(19) United States
(12) Patent Application Publication
(10) Pub. No.: US 2026/0237134 A1
(43) Pub. Date: Aug. 13, 2026

(54) INFORMATION PROCESSING DEVICE, INFORMATION PROCESSING METHOD, AND RECORDING MEDIUM

(71) Applicant: Sony Group Corporation, Tokyo (JP)

(72) Inventor: Kentaro FUKAMIZU, Tokyo (JP)

(73) Assignee: Sony Group Corporation, Tokyo (JP)

(21) Appl. No.: 19/155,258

(22) PCT Filed: Feb. 6, 2024
(86) PCT No.: PCT/JP2024/003835

§ 371 Date: Aug. 11, 2025

(30) Foreign Application Priority Data
Feb. 22, 2023 (JP) 2023-026338

(51) Int. Cl. G06T 13/40; G06T 19/20

(52) U.S. Cl. CPC G06T 13/40; G06T 19/20; G06T 2219/2021

(57) ABSTRACT

The present disclosure relates to an information processing device, an information processing method, and a recording medium enabling a more realistic representation of neck deformation.

A neck mesh acquiring unit acquires a neck mesh representing deformation of only a neck region from a training mesh representing a correlation between facial expression and neck deformation, and a first learning unit learns a plurality of neck base shapes and coefficients corresponding to, on a one-to-one basis, the plurality of neck base shapes on the basis of the acquired neck mesh. The present disclosure can be applied to Digital Human technology for representing realistic humans using 3DCG.

### TECHNICAL FIELD

The present disclosure relates to an information processing device, an information processing method, and a recording medium, and more specifically, to an information processing device, an information processing method, and a recording medium enabling a more realistic representation of neck deformation.

### BACKGROUND ART

In a case of realistically representing deformation of a person's neck using three-dimensional computer graphics (3DCG), Blend shape-based representations are widely used. Blend shape is one of the methods used to achieve animation representation in 3DCG. In Blend shape, a new shape can be represented by linearly combining several base shapes using their corresponding coefficients.

In 3DCG production sites, a process called shot sculpting for creating neck animation by hand-tuning Blend shape coefficients for each animation frame is adopted. However, as the hand-tuning required for each frame impose a high workload, a method has been proposed to automate the shot sculpting process for the neck region (see Non-Patent Document 1).

In the method disclosed in Non-Patent Document 1, from a pre-recorded neck mesh sequence representing neck deformation across a plurality of utterance states, base shapes of Blend shape and coefficients for each frame of the neck mesh sequence are learned through principal component analysis. During the pre-recording, not only neck deformation but also utterances are also recorded simultaneously, and an utterance feature calculated from audio and a Blend shape coefficient of the corresponding frame are associated with each other using linear regression. As a result, when a person's neck mesh is created through inference, by recording audio corresponding to a facial expression, it is possible to output the corresponding Blend shape coefficient, which contributes to automating the shot sculpting process.

### CITATION LIST

### Non-Patent Document

Non-Patent Document 1: Yilong Liu, Chengwei Zheng, Feng Xu, Xin Tong, and Baining Guo, “Data-Driven 3D Neck Modeling and Animation”, TVCG: IEEE Transactions on Visualization and Computer Graphics, 2020

### SUMMARY OF THE INVENTION

### Problems to be Solved by the Invention

The conventional approach has not considered acquiring neck base shapes based on the facial expressions and the degree of neck rotation. Therefore, it has not always been possible to realistically represent neck deformation.

The present disclosure has been made in view of such circumstances, and it is therefore an object of the present disclosure to enable a more realistic representation of neck deformation.

### Solutions to Problems

An information processing device of the present disclosure includes: a neck mesh acquiring unit that acquires a neck mesh representing deformation of only a neck region from a training mesh representing a correlation between facial expression and neck deformation; and a first learning unit that learns a plurality of neck base shapes and coefficients corresponding to, on a one-to-one basis, the plurality of neck base shapes on the basis of the neck mesh that has been acquired.

An information processing method of the present disclosure includes: causing an information processing device to acquire a neck mesh representing deformation of only a neck region from a training mesh representing a correlation between facial expression and neck deformation; and causing the information processing device to learn a plurality of neck base shapes and coefficients corresponding to, on a one-to-one basis, the plurality of neck base shapes on the basis of the neck mesh that has been acquired.

A computer-readable recording medium of the present disclosure stores a program for causing a computer to perform processing, the processing including: acquiring a neck mesh representing deformation of only a neck region from a training mesh representing a correlation between facial expression and neck deformation; and learning a plurality of neck base shapes and coefficients corresponding to, on a one-to-one basis, the plurality of neck base shapes on the basis of the neck mesh that has been acquired.

According to the present disclosure, a neck mesh representing deformation of only a neck region is acquired from a training mesh representing a correlation between facial expression and neck deformation, and a plurality of neck base shapes and coefficients corresponding to, on a one-to-one basis, the plurality of neck base shapes are learned on the basis of the neck mesh that has been acquired.

### BRIEF DESCRIPTION OF DRAWINGS

FIG. 1 is a diagram illustrating a functional overview of an information processing device to which the technology according to the present disclosure is applied.

FIG. 2 is a diagram for describing how to model neck deformation using Blend shape.

FIG. 3 is a block diagram illustrating an example of a functional configuration of a first learning mechanism.

FIG. 4 is a flowchart for describing a flow of first-phase learning.

FIG. 5 is a diagram illustrating an example of a training mesh sequence.

FIG. 6 is a diagram illustrating examples of training meshes before and after the Inverse LBS is applied.

FIG. 7 is a diagram for describing subtraction processing to subtract a facial expression mesh from a training mesh.

FIG. 8 is a diagram for describing a neck region that undergoes deformation.

FIG. 9 is a block diagram illustrating an example of a functional configuration of a second learning mechanism.

FIG. 10 is a flowchart for describing a flow of second-phase learning.

FIG. 11 is a diagram for describing the degree of displacement of facial expression feature points and the degree of neck rotation.

FIG. 12 is a block diagram illustrating an example of a functional configuration of an inference mechanism.

FIG. 13 is a flowchart for describing a flow of inference.

FIG. 14 is a diagram for describing an example of the effects of the technology according to the present disclosure.

FIG. 15 is a block diagram illustrating a configuration example of a computer.

### MODE FOR CARRYING OUT THE INVENTION

Hereinafter, modes for carrying out the present disclosure (hereinafter referred to as embodiments) will be described. Note that the description will be given in the following order.
1. Background
2. Overview of technology according to present disclosure
3. Modeling of neck deformation using Blend shape
4. Configuration and operation of first learning mechanism
5. Configuration and operation of second learning mechanism
6. Configuration and operation of inference mechanism
7. Effects of technology according to present disclosure
8. Configuration example of computer

### 1. BACKGROUND

The technology according to the present disclosure is a part of Digital Human technology that represents realistic humans using 3DCG, and is a technology to achieve realistic and smooth neck deformation animation linked to the utterance state and the degree of neck rotation. The technology according to the present disclosure is based on the premise that a facial expression mesh representing only changes in facial expressions generated using Facial Deformation technology and a rig pose associated with the facial expression mesh, the rig pose being generated using motion capture technology or the like, are separately provided.

Currently, in a case where the rig pose is applied to the facial expression mesh under this premise, to achieve realistic deformation of jaw, neck, and occipital regions, which serve as connection portions between a region deformed by the facial expression and rig and a region deformed only by the rig, hand-tuning of animation remains the predominant method.

For example, as the shape of the nape of the neck and larynx is linked to facial expressions and head orientations, an animator models a realistic neck shape with reference to the posture of provided facial expression mesh and full-body mesh for all animation frames.

As described above, in 3DCG production sites, a process called shot sculpting for creating neck animation by hand-tuning Blend shape coefficients for each animation frame is adopted. However, as the hand-tuning required for each frame imposes a high workload, Non-Patent Document 1 has proposed a method to automate the shot sculpting process for the neck region.

In the method disclosed in Non-Patent Document 1, from a pre-recorded neck mesh sequence representing neck deformation across a plurality of utterance states, base shapes of Blend shape and coefficients for each frame of the neck mesh sequence are learned through principal component analysis. During the pre-recording, not only neck deformation but also utterances are also recorded simultaneously, and an utterance feature calculated from audio and a Blend shape coefficient of the corresponding frame are associated with each other using linear regression. As a result, when a person's neck mesh is created through inference, by recording audio corresponding to a facial expression, it is possible to output the corresponding Blend shape coefficient, which contributes to automating the shot sculpting process.

The method disclosed in Non-Patent Document 1 requires recording audio during both learning and inference. In a case where microphone performance and recording conditions differ significantly between learning and inference, the shape of a neck mesh output during inference significantly differs in quality from the shape of the neck mesh during learning. On the other hand, in the technology according to the present disclosure, the inference of Blend shape coefficients does not depend on audio signals, which is highly convenient for pre-recording.

Furthermore, in the method disclosed in Non-Patent Document 1, the neck deformation based on the facial expressions and the neck deformation according to the degree of neck rotation are treated as independent events. In practice, the neck deformation based on the facial expressions and the neck deformation according to the degree of neck rotation are in a relationship of dependency, and in a case where a complicated facial expression is combined with an extreme degree of neck rotation, there is a possibility that the neck shape calculated by the method disclosed in Non-Patent Document 1 may collapse.

For example, in a case where the head is oriented downward with its mouth fully open like when pronouncing “A” in Japanese, the skin of the submandibular region and the skin around the larynx come into contact with each other. At this time, in real humans, since the neck deformation based on the facial expressions and the neck deformation according to the degree of neck rotation are in a relationship of dependency as described above, the skin of the submandibular region and the skin around the larynx deform as a result of mutual interaction based on the law of action and reaction. However, in the method disclosed in Non-Patent Document 1, a model in which the neck deformation based on the facial expressions and the neck deformation according to the degree of neck rotation are considered independent is adopted, so the law of action and reaction is not applied, and the mesh of the submandibular region is pressing into the larynx.

Moreover, in a case where the head is oriented upward with its mouth widely open like when pronouncing “I” in Japanese, the neck muscles are pulled by the facial muscles in real humans, but with the method disclosed in Non-Patent Document 1, representing such deformation is also challenging. On the other hand, in the technology according to the present disclosure, the neck deformation based on the facial expressions and the neck deformation according to the degree of neck rotation are modeled as dependent phenomena, making the neck shape less likely to collapse.

The present disclosure provides a method to dynamically and smoothly deform the neck shape including the jaw and the occipital region on the basis of the facial expressions and the degree of neck rotation.

### <2. Overview of Technology According to Present Disclosure>

In the technology according to the present disclosure, to dynamically and smoothly deform the neck shape on the basis of the facial expressions and the degree of neck rotation, the neck deformation shape are modeled using Blend shape through a two-phase learning mechanism. Blend shape is one of the methods used to achieve animation representation in 3DCG. In Blend shape, a new shape can be represented by linearly combining several base shapes (three-dimensional models) using their corresponding coefficients (hereinafter, referred to as Blend shape coefficients).

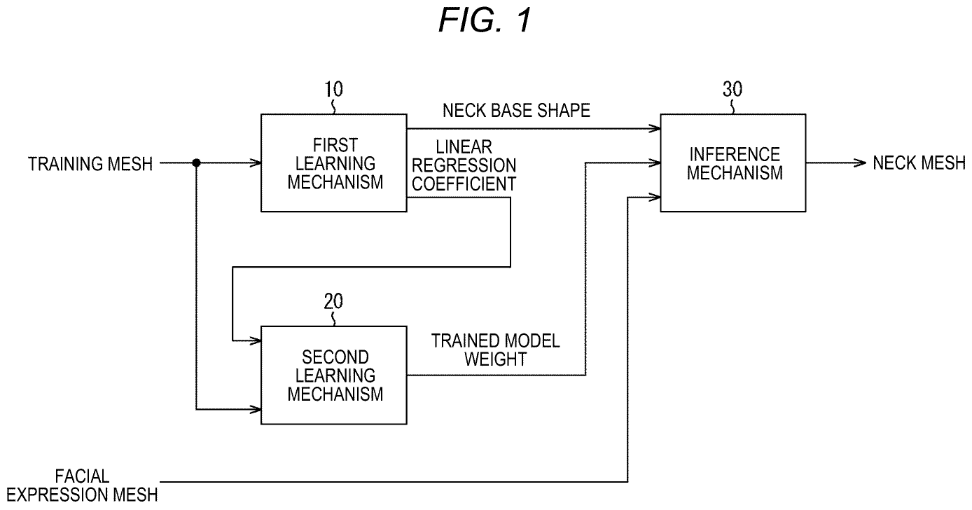

FIG. 1 is a diagram illustrating a functional overview of an information processing device to which the technology according to the present disclosure is applied.

An information processing device 1 illustrated in FIG. 1 is configured as, for example, a computer that operates by executing a predetermined program. In the information processing device 1, a first learning mechanism 10, a second learning mechanism 20, and an inference mechanism 30 are implemented as functional blocks. The first learning mechanism 10, the second learning mechanism 20, and the inference mechanism 30 may be implemented by separately configured information processing devices (computers).

The first learning mechanism 10 learns a plurality of neck base shapes of Blend shape and their corresponding linear regression coefficients through principal component analysis using, as training data (training mesh), some 3DCG animations where the facial expression remains fixed in a specific state while the neck rotates. At this time, by extracting a neck mesh representing only neck deformation from the training mesh including combinations of facial expressions and neck deformations using the known Facial Deformation technology, it is possible to obtain more accurate base shapes than before.

Assuming that the facial expression and the degree of neck rotation are correlated with the neck shape, the second learning mechanism 20 trains a neural network that outputs the coefficient corresponding to the base shape of Blend shape using the three-dimensional positions of some vertices on the facial expression mesh and the degree of neck bone rotation in the rig associated with the facial expression mesh as input. Here, the neural network is trained using features representing deformation of the training mesh as input and the linear regression coefficients learned by the first learning mechanism 10 as ground truth data, and its weights (trained model weights) are output.

The inference mechanism 30 inputs features representing deformation of the desired facial expression mesh to the neural network trained by the second learning mechanism 20 to infer the Blend shape coefficients using the trained model weights. Then, by linearly combining the neck base shapes learned by the first learning mechanism 10 using the inferred Blend shape coefficients, it is possible to obtain a neck mesh having a shape based on the desired facial expression and degree of neck rotation.

### <3. Modeling of Neck Deformation Using Blend Shape>

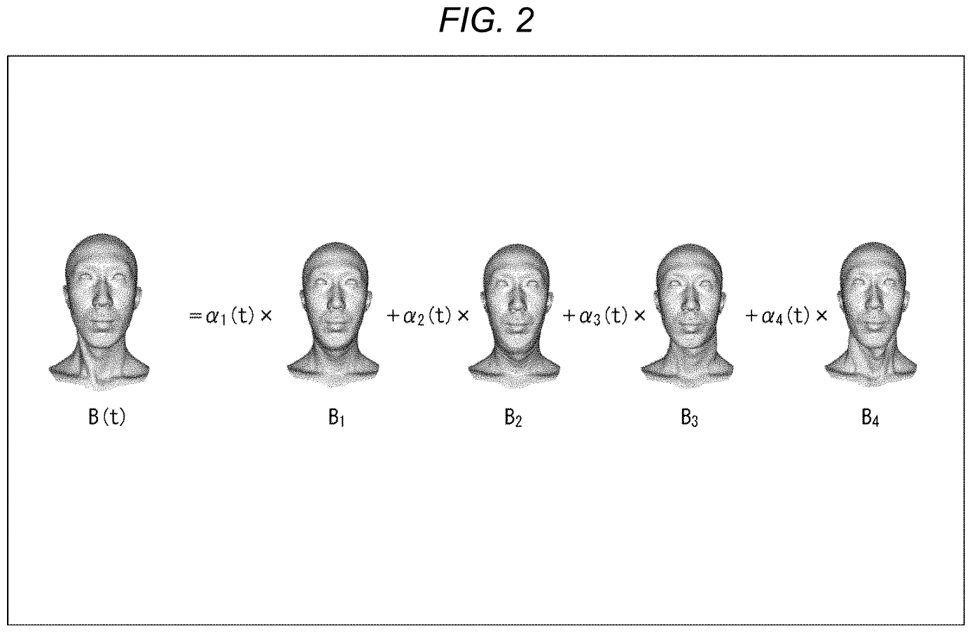

In the technology according to the present disclosure, neck deformation is modeled using Blend shape as illustrated in FIG. 2. The mesh generation using Blend shape is represented by the following equation.

$$B ( t ) = {\sum }_{p = 0}^{P} {α}_{p} ( t ) {B}_{p} \qquad [ Math . 1 ]$$

B(t) represents a result when Blend shape is applied at a certain time frame t, αp(t) represents a Blend shape coefficient corresponding to a base p, Bₚ represents a base shape of the base p, and P represents the total number of the bases of Blend shape. In the example illustrated in FIG. 2, four base shapes B₁ to B₄ are linearly combined using their corresponding Blend shape coefficients α₁ (t) to α₄(t) to produce a mesh B(t) having a desired shape.

The learning based on the technology according to the present disclosure includes first-phase learning to learn the base shape Bₚ from the training mesh and second-phase learning to associate the facial expression and degree of neck rotation with the Blend shape coefficient αp(t). Furthermore, it is assumed that the training mesh used in the technology according to the present disclosure is associated with the rig using the linear blend skinning (LBS) technology. That is, it is possible to control the mesh's head orientation by editing poses using the rig. A vertex position v′ᵢ after the LBS is applied corresponding to a certain vertex position vᵢ on the mesh B(t) is calculated using the following equation.

$${v}_{i}^{′} = {\sum }_{j = 0}^{J} {w}_{i j} {M}_{j} {v}_{i} \qquad [ Math . 2 ]$$

Here, J represents the total number of bones in the rig, wᵢⱼ represents the degree of impact of a bone j on the vertex position vᵢ, and Mⱼ represents a coordinate transformation matrix including information regarding the rotation and position of the bone j.

### <4. Configuration and Operation of First Learning Mechanism>

First, the configuration and operation of the first learning mechanism 10 that implements the first-phase learning will be described.

### (Configuration of First Learning Mechanism)

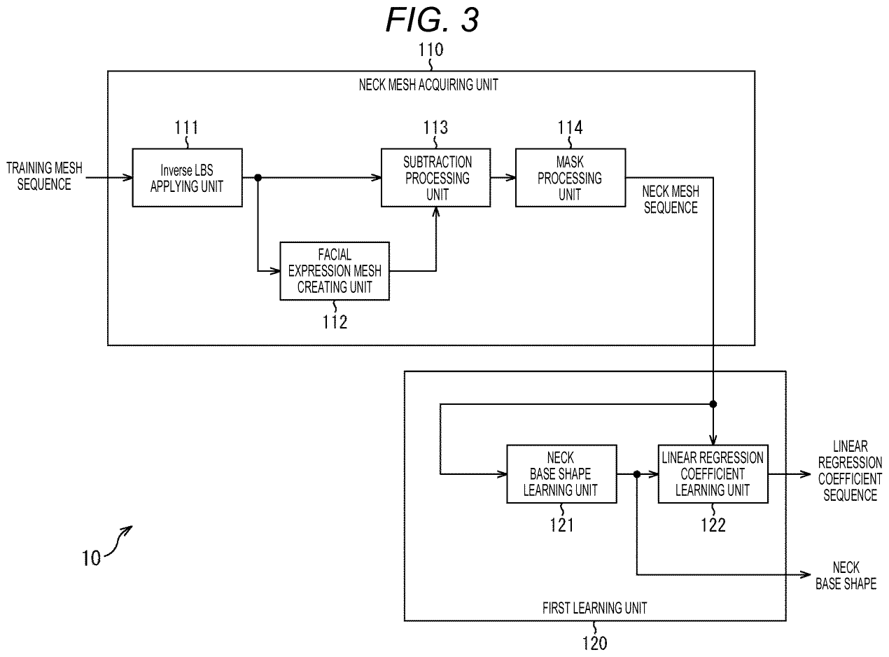

FIG. 3 is a block diagram illustrating an example of the functional configuration of the first learning mechanism 10.

As illustrated in FIG. 3, the first learning mechanism 10 includes a neck mesh acquiring unit 110 and a first learning unit 120.

The neck mesh acquiring unit 110 acquires a neck mesh representing the deformation of only the neck region from the training mesh representing the correlation between facial expression and neck deformation. In practice, a neck mesh sequence is acquired from a training mesh sequence that is animation data including the training mesh. Hereinafter, the training mesh sequence and the like are also simply referred to as a training mesh and the like where appropriate.

The neck mesh acquiring unit 110 includes an Inverse LBS applying unit 111, a facial expression mesh creating unit 112, a subtraction processing unit 113, and a mask processing unit 114.

The Inverse LBS applying unit 111 applies the Inverse LBS to convert the input training mesh (training mesh sequence) into a mesh before the LBS is applied, and provides the resultant mesh to the facial expression mesh creating unit 112 and the subtraction processing unit 113.

The facial expression mesh creating unit 112 creates a facial expression mesh representing the same deformation as the training mesh at each time frame on the basis of the training mesh sequence to which the Inverse LBS is applied, and provides the facial expression mesh to the subtraction processing unit 113.

The subtraction processing unit 113 performs subtraction processing to subtract the facial expression mesh from the training mesh to which the Inverse LBS is applied, and provides the training mesh from which the facial expression mesh has been subtracted to the mask processing unit 114.

The mask processing unit 114 performs mask processing to mask a region excluding the neck region in the training mesh from which the facial expression mesh has been subtracted to acquire a neck mesh (neck mesh sequence) representing the deformation of only the neck region.

The first learning unit 120 learns a plurality of neck base shapes serving as the base shapes of the neck and coefficients corresponding to the plurality of neck base shapes on the basis of the neck mesh (neck mesh sequence) acquired by the neck mesh acquiring unit 110.

The first learning unit 120 includes a neck base shape learning unit 121 and a linear regression coefficient learning unit 122.

The neck base shape learning unit 121 learns a plurality of neck base shapes through temporal principal component analysis on the neck mesh (neck mesh sequence) acquired by the neck mesh acquiring unit 110.

The linear regression coefficient learning unit 122 learns linear regression coefficients for each neck base shape through linear regression using the neck mesh (neck mesh sequence) acquired by the neck mesh acquiring unit 110 and the plurality of neck base shapes learned by the neck base shape learning unit 121.

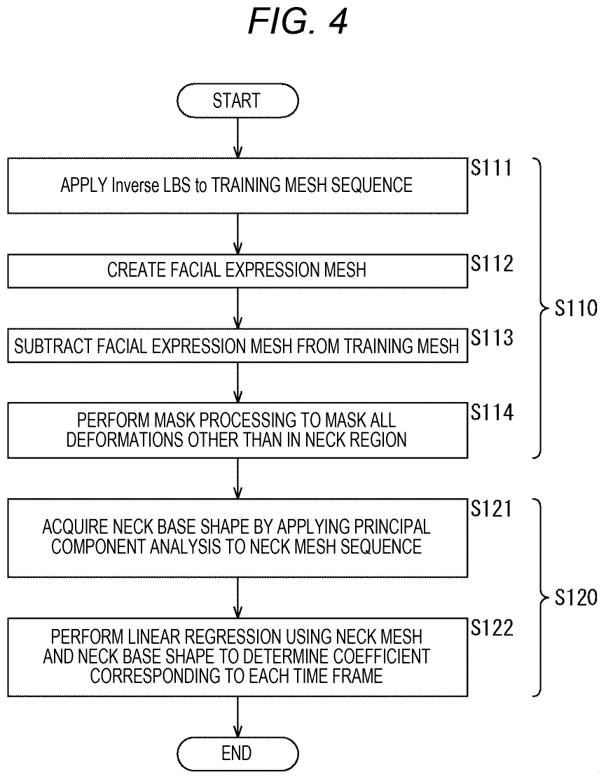

(Operation of first learning mechanism) The flow of the first-phase learning performed by the first learning mechanism 10 will be described with reference to the flowchart in FIG. 4. The first-phase learning is performed for the purpose of generating training data for the neck base shapes Bₚ and the Blend shape coefficient αp(t) corresponding to the neck base shapes Bₚ.

In step S110, the neck mesh acquiring unit 110 acquires a neck mesh sequence from the training mesh sequence. Then, in step S120, the first learning unit 120 learns neck base shapes serving as the base shapes of the neck and coefficients corresponding to the neck base shapes on the basis of the acquired neck mesh sequence.

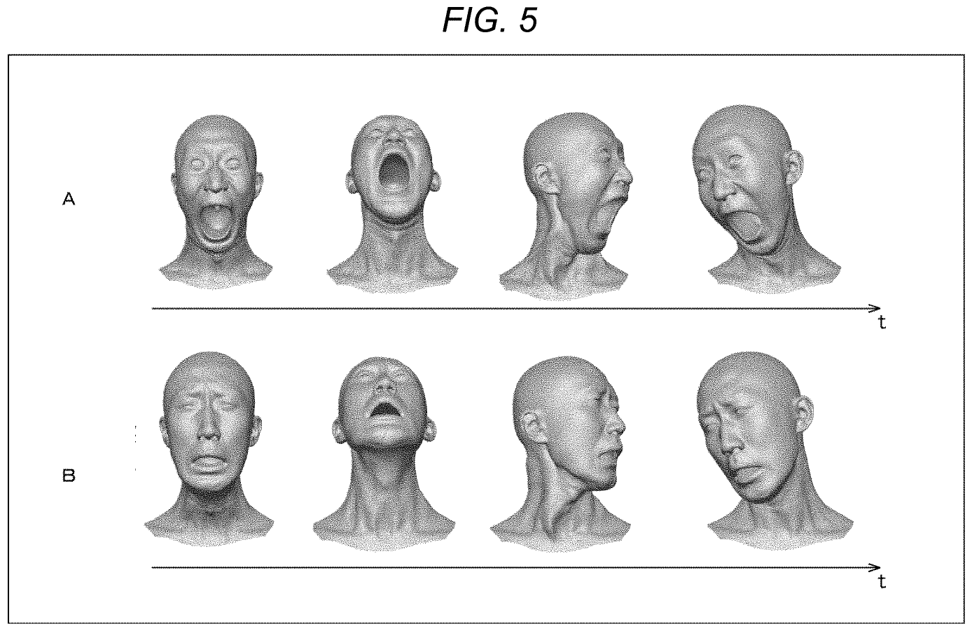

As illustrated in FIG. 5, the training mesh sequence input to the first learning mechanism 10 is animation data based on 3D mesh data of a pre-scanned person's head with its mouth open in several shapes while the head rotates in several directions. A of FIG. 5 illustrates an example of a training mesh sequence representing the head oriented in four directions with its mouth fully open like when pronouncing “A” in Japanese, and B of FIG. 5 illustrates an example of a training mesh sequence representing the head oriented in four directions with its mouth widely open like when pronouncing “I” in Japanese.

In the technology according to the present disclosure, it is assumed that such a training mesh sequence maintains a consistent mesh topology (geometric surface characteristics) over time. Furthermore, it is assumed that the orientation of the head in the training mesh sequence is controlled by the rig (bone) associated with the training mesh at each time frame t.

Return to the flowchart in FIG. 4, the details of the first-phase learning will be described.

In step S111, the Inverse LBS applying unit 111 applies the Inverse LBS to the training mesh sequence.

In the technology according to the present disclosure, as the neck mesh is generated before the LBS is applied, it is necessary to learn Blend shape after converting the training mesh to which the LBS is applied by the rig into the mesh before the LBS is applied. Therefore, the conversion is called Inverse LBS, and a certain vertex position vᵢ on the mesh B(t) before the LBS is applied can be determined using the following equation.

$${v}_{i} = {( {\sum }_{j = 0}^{J} {w}_{ij} {M}_{j} )}^{- 1} {v}_{i}^{′} \qquad [ Math . 3 ]$$

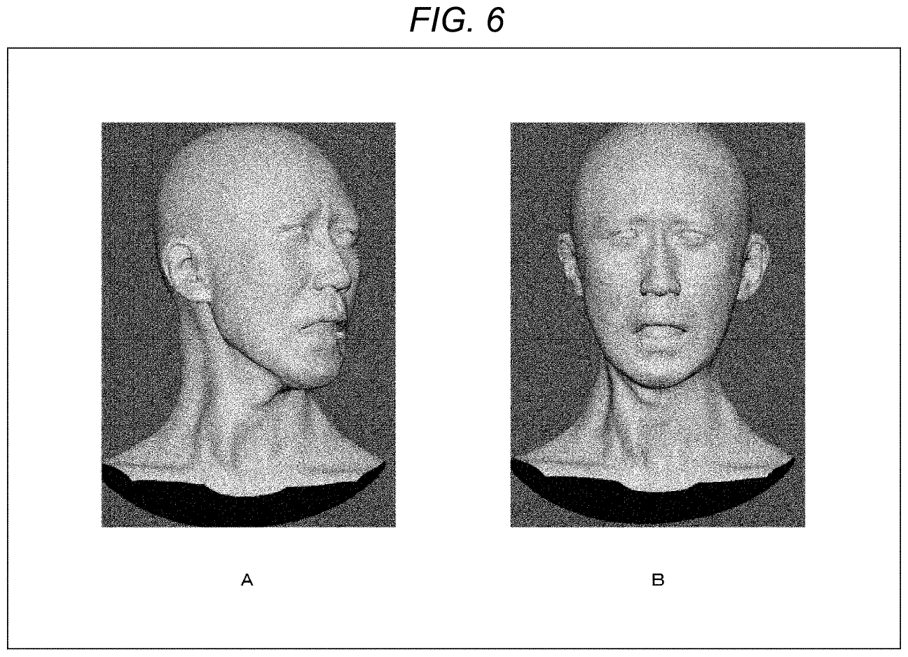

FIG. 6 is a diagram illustrating examples of training meshes before and after the Inverse LBS is applied.

A of FIG. 6 illustrates a training mesh before the Inverse LBS is applied, and B of FIG. 6 illustrates a training mesh after the Inverse LBS is applied.

As illustrated in FIG. 6, in the training mesh before the Inverse LBS is applied, the head orientation is controlled by the associated rig. On the other hand, in the training mesh after the Inverse LBS is applied, the rig association is reset, and the head orientation returns to its default state.

Return to the flowchart in FIG. 4, in step S112, the facial expression mesh creating unit 112 creates a facial expression mesh from the training mesh sequence to which the Inverse LBS is applied using the Facial

Deformation technology. In the created facial expression mesh, only the facial region undergoes deformation, while the neck region remains unchanged.

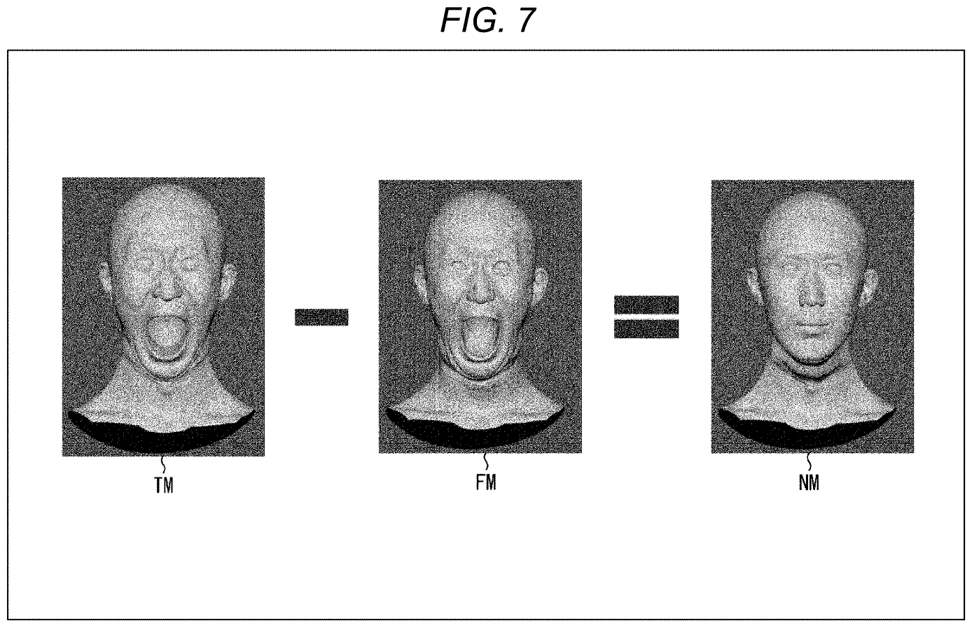

In step S113, as illustrated in FIG. 7, the subtraction processing unit 113 subtracts the facial expression mesh FM created by the facial expression mesh creating unit 112 from the training mesh TM to which the Inverse LBS is applied to extract the neck mesh NM that deforms only in the neck region.

However, as the deformation of the facial region of the training mesh TM and the deformation of the facial region of the facial expression mesh FM do not fully align, even the subtraction processing performed by the subtraction processing unit 113 cannot fully eliminate the deformation of the facial region from the training mesh TM.

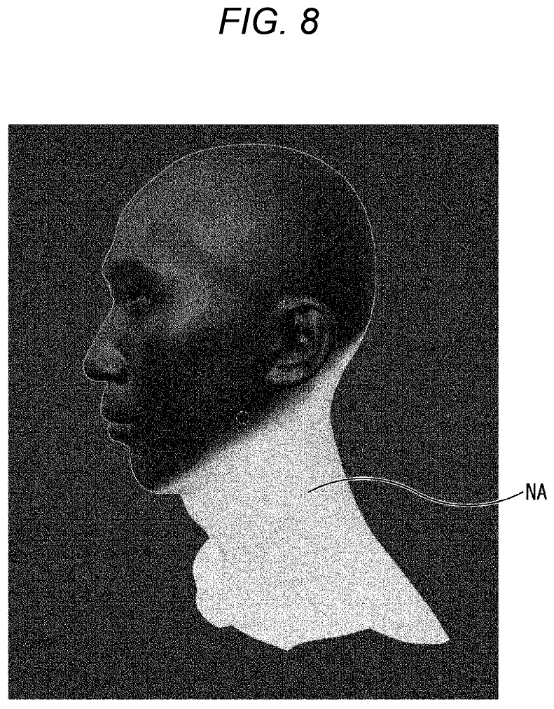

Therefore, in step S114, the mask processing unit 114 performs the mask processing to mask all deformations other than in the neck region that undergoes deformation in the technology according to the present disclosure. In the technology according to the present disclosure, a region to which white color is applied of the mesh illustrated in FIG. 8 is a neck region NA that undergoes deformation. The neck region NA includes a submandibular region and an occipital region. This can prevent an error in the Facial Deformation technology from being reflected in the neck base shape.

As described above, the neck mesh (neck mesh sequence) representing the deformation of only the neck region is acquired.

In step S121, the neck base shape learning unit 121 learns the neck base shape Bₚ by applying temporal principal component analysis to the acquired neck mesh (neck mesh sequence).

Then, in step S122, the linear regression coefficient learning unit 122 performs linear regression using the acquired neck mesh (neck mesh sequence) and the learned neck base shape Bₚ to determine the linear regression coefficient (Blend shape coefficient) corresponding to each time frame t. Here, in a case where the neck mesh sequence is denoted as BG (t), the Blend shape coefficient αₚ^{G}(t) corresponding to each time frame t is determined by performing linear regression to satisfy the following equation.

$${B}^{G} ( t ) = {\sum }_{p = 0}^{P} {α}_{p}^{G} ( t ) {B}_{p} \qquad [ Math . 4 ]$$

The Blend shape coefficient αₚ^{G}(t) is used as ground truth data in the second-phase learning to be described later.

In the above-described processing, by extracting the neck mesh representing only the neck deformation from the training mesh including combinations of facial expressions and neck deformations using the Facial Deformation technology, it is possible to acquire the neck base shapes based on the facial expressions and the degree of neck rotation. That is, it is possible to obtain more accurate neck base shapes than before, which in turn allows for a more realistic representation of neck deformation.

### <5. Configuration and Operation of Second Learning Mechanism>

Next, the configuration and operation of the second learning mechanism 20 that implements the second-phase learning will be described.

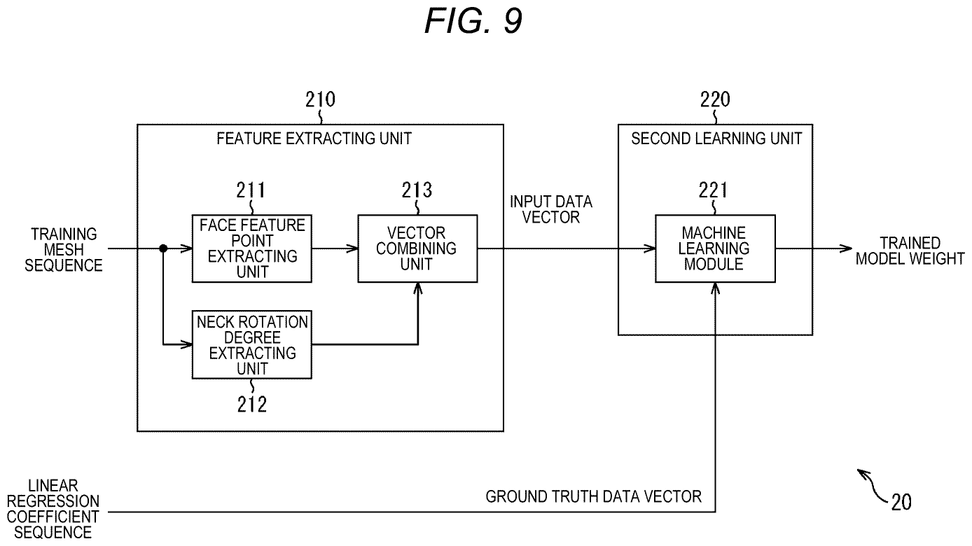

(Configuration of second learning mechanism) FIG. 9 is a block diagram illustrating an example of the functional configuration of the second learning mechanism 20.

As illustrated in FIG. 9, the second learning mechanism 20 includes a feature extracting unit 210 and a second learning unit 220.

The feature extracting unit 210 extracts, from the training mesh (training mesh sequence) used in the first-phase learning, features representing the deformation of the training mesh.

The feature extracting unit 210 includes a face feature point extracting unit 211, a neck rotation degree extracting unit 212, and a vector combining unit 213.

The face feature point extracting unit 211 extracts, from the training mesh used in the first-phase learning, a degree of displacement of facial expression feature points as the features representing the deformation of the training mesh, and provides the degree of displacement to the vector combining unit 213.

The neck rotation degree extracting unit 212 extracts, from the training mesh used in the first-phase learning, a degree of neck rotation associated with the training mesh as the features representing the deformation of the training mesh, and provides the degree of neck rotation to the vector combining unit 213.

The vector combining unit 213 combines the degree of displacement of facial expression feature points received from the face feature point extracting unit 211 and the degree of neck rotation received from the neck rotation degree extracting unit 212 into a one-dimensional vector, and provides the one-dimensional vector to the second learning unit 220 as an input data vector indicating the features representing the deformation of the training mesh.

The second learning unit 220 trains, using the features (input data vector) representing the deformation of the training mesh as input and the linear regression coefficient sequence (Blend shape coefficient) for each neck base shape learned by the first learning unit 120 as a ground truth data vector, a machine learning module 221 that infers Blend shape coefficients corresponding to features representing deformation of an arbitrary facial expression mesh.

### (Operation of Second Learning Mechanism)

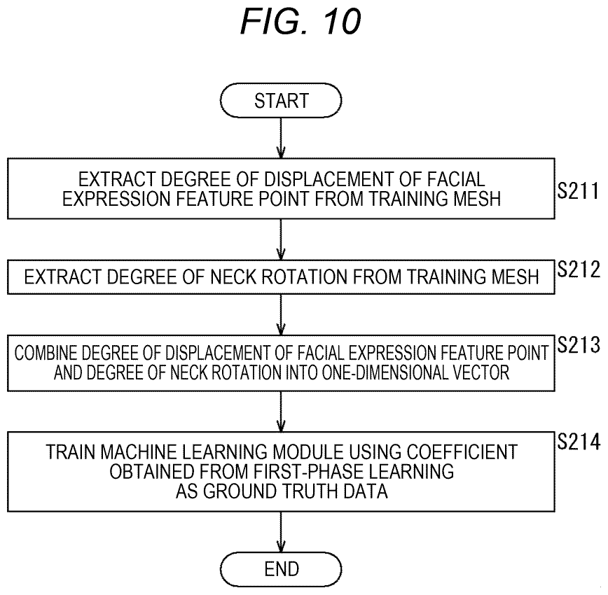

The flow of the second-phase learning performed by the second learning mechanism 20 will be described with reference to the flowchart in FIG. 10. The second-phase learning is performed for the purpose of training the machine learning module 221 that infers the Blend shape coefficients on the basis of the facial expressions and the degree of neck rotation.

In step S211, the face feature point extracting unit 211 extracts, from the training mesh used in the first-phase learning, the degree of displacement of facial expression feature points.

In step S212, the neck rotation degree extracting unit 212 extracts, from the training mesh used in the first-phase learning, the degree of neck rotation associated with the training mesh.

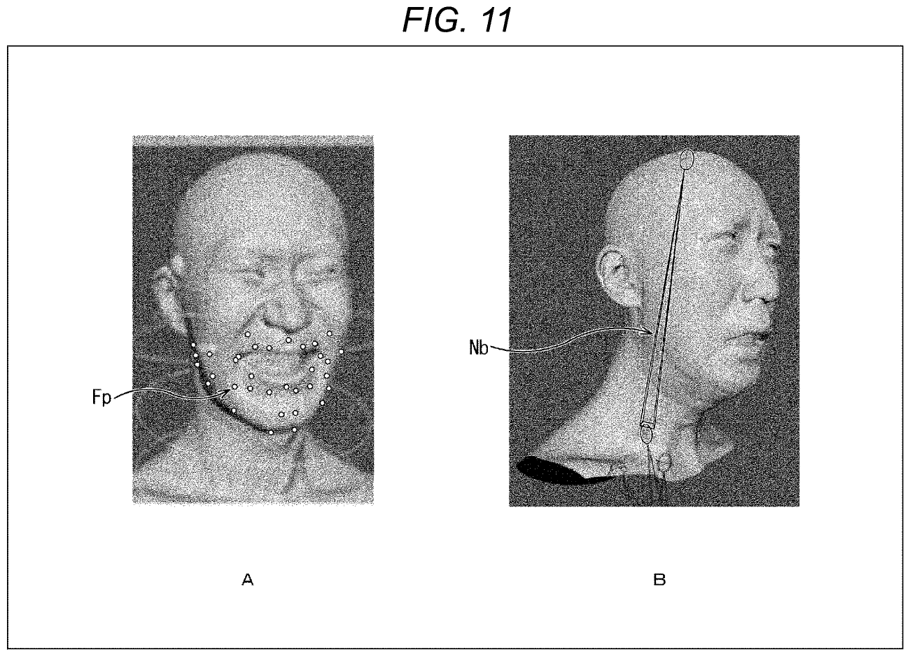

As illustrated in A of FIG. 11, as the degree of displacement of facial expression feature points, a degree of displacement, relative to the neutral facial expression, of three-dimensional positions of a plurality of vertices Fp around the mouth specified in advance in the training mesh is used. Furthermore, as illustrated in B of FIG. 11, the Euler angles of the neck bone Nb in the rig associated with the training mesh are used as the degree of neck rotation.

In step S213, the vector combining unit 213 combines the degree of displacement of facial expression feature points and the degree of neck rotation extracted from the training mesh into a one-dimensional vector, and inputs the one-dimensional vector to the machine learning module 221 as an input data vector indicating the features representing the deformation of the training mesh.

Then, in step S214, the second learning unit 220 trains the machine learning module 221 using the input data vector as input and the Blend shape coefficient αₚ^{G}(t) obtained from the first-phase learning as ground truth data. The training of the machine learning module 221 is performed for all possible input-output combinations corresponding to each time frame t, and weights upon completion of training (trained model weights) are retained as output.

Through to the above-described processing, the neck deformation based on the facial expressions and the neck deformation according to the degree of neck rotation can be modeled as dependent events, so it is possible to prevent the neck shape from collapsing during inference.

Furthermore, the training of the machine learning module 221 enables the automation of the shot sculpting process that traditionally requires hand-tuning of the Blend shape coefficients. Moreover, as the facial expression feature points input to the machine learning module 221, only some vertices around the mouth are used, rather than all the vertices of the training mesh, thereby making it possible to keep the input to the machine learning module 221 low-dimensional. This contributes to memory efficiency and fast training and inference of the machine learning module 221.

### <6. Configuration and Operation of Inference Mechanism>

Finally, the configuration and operation of the inference mechanism 30 that enables inference using both the output of the first learning mechanism 10 and the output of the second learning mechanism 20 will be described.

### (Configuration of Inference Mechanism)

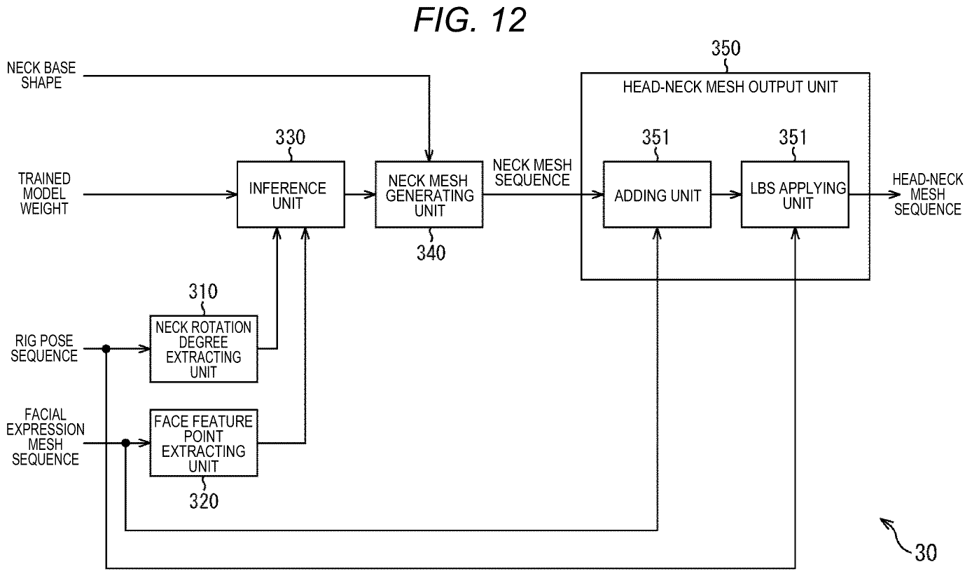

FIG. 12 is a block diagram illustrating an example of the functional configuration of the inference mechanism 30.

As illustrated in FIG. 12, the inference mechanism 30 includes a neck rotation degree extracting unit 310, a face feature point extracting unit 320, an inference unit 330, a neck mesh generating unit 340, and a head-neck mesh output unit 350.

The neck rotation degree extracting unit 310 extracts, as features representing the deformation of a desired facial expression mesh sequence, a degree of neck rotation in a rig pose sequence associated with the facial expression mesh sequence, and provides the degree of neck rotation to the inference unit 330.

The face feature point extracting unit 320 extracts, as the features representing the deformation of the desired facial expression mesh sequence, a degree of displacement of facial expression feature points in the facial expression mesh sequence, and provides the degree of displacement to the inference unit 330.

The inference unit 330 inputs the features representing the deformation of the desired facial expression mesh sequence to the machine learning module 221 trained by the second learning unit 220 to infer the Blend shape coefficients using the trained model weights obtained from the second learning unit 220. The inferred Blend shape coefficients are provided to the neck mesh generating unit 340.

The neck mesh generating unit 340 generates a neck mesh sequence corresponding to the facial expression mesh sequence by linearly combining the neck base shapes learned by the first learning unit 120 using the Blend shape coefficients received from the inference unit 330, and provides the neck mesh sequence to the head-neck mesh output unit 350.

The head-neck mesh output unit 350 outputs a head-neck mesh sequence obtained by applying the features representing the deformation of the desired facial expression mesh sequence to the neck mesh sequence received from the neck mesh generating unit 340. The head-neck mesh output unit 350 includes an adding unit 351 and an LBS applying unit 352.

The adding unit 351 adds the degree of displacement of the desired facial expression mesh sequence to the neck mesh sequence received from the neck mesh generating unit 340 to generate a head-neck mesh sequence with which no rig is associated, and provides the head-neck mesh sequence to the LBS applying unit 352.

The LBS applying unit 352 applies the LBS to associate a rig corresponding to a desired pose with the head-neck mesh sequence received from the adding unit 351.

### (Operation of Inference Mechanism)

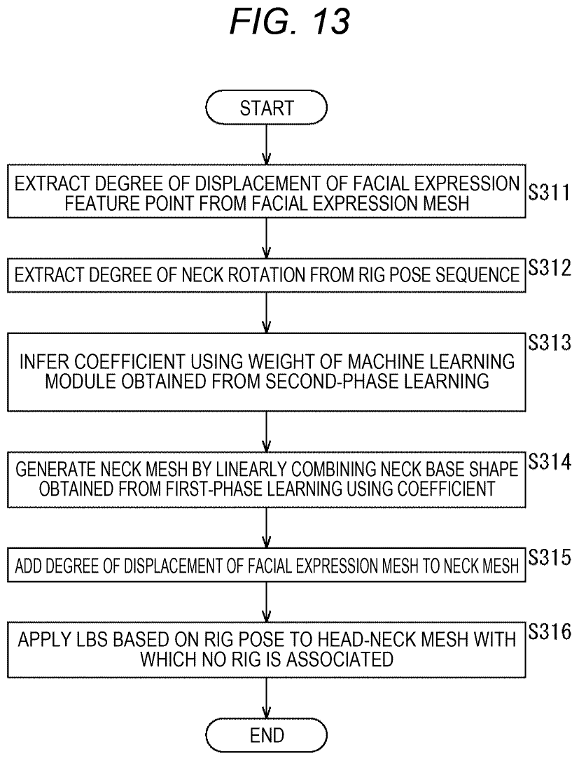

The flow of inference performed by the inference mechanism 30 will be described with reference to the flowchart in FIG. 13. The inference here is performed for the purpose of generating the corresponding neck shape when a new facial expression mesh and rig pose sequence different from the first-phase learning and the second-phase learning are provided.

In step S311, the face feature point extracting unit 320 extracts, from the facial expression mesh provided by the Facial Deformation technology, a degree of displacement of facial expression feature points in the facial expression mesh.

In step S312, the neck rotation degree extracting unit 310 extracts a degree of neck rotation associated with the facial expression mesh from the rig pose sequence provided by motion capture technology or manual animation.

Similar to the second-phase learning, as the degree of displacement of facial expression feature points, a degree of displacement, relative to the neutral facial expression, of three-dimensional positions of a plurality of vertices around the mouth specified in advance in the facial expression mesh is used. As the degree of neck rotation, the Euler angles of the neck bone in the rig associated with the facial expression mesh are used.

In step S313, the inference unit 330 infers the Blend shape coefficient αp(t) using the extracted degree of displacement of facial expression feature points and degree of neck rotation as input and the weights of the machine learning module 221 obtained from the second-phase learning.

In step S314, the neck mesh generating unit 340 generates a neck mesh by linearly combining the neck base shapes Bₚ obtained from the first-phase learning using the inferred Blend shape coefficients αp(t).

In step S315, the adding unit 351 adds the degree of displacement of the facial expression mesh to the generated neck mesh to generate a head-neck mesh with which no rig is associated. Note that, in the present disclosure, it can be considered that the head-neck mesh includes a head mesh including a facial expression mesh and a neck mesh.

In step S316, the LBS applying unit 352 applies the LBS based on rig poses to the head-neck mesh with which no rig is associated. As a result, it is possible to obtain a head-neck mesh that includes combinations of face expressions and neck deformation and whose head orientation is controlled by the rig.

### <7. Effects of Technology According to Present Disclosure>

The effects of the technology according to the present disclosure will be described.

In the technology according to the present disclosure, it is possible to obtain a highly accurate neck mesh from the training mesh using the Facial Deformation technology. Specifically, the displacement applied to the neutral facial expression mesh to prevent it from collapsing can be obtained with high accuracy, especially in the submandibular region. By applying this displacement when creating the neck base shape, it is possible to achieve automatic elimination of collapse occurring when the submandibular region and the neck come into contact with each other, which is challenging with the related art.

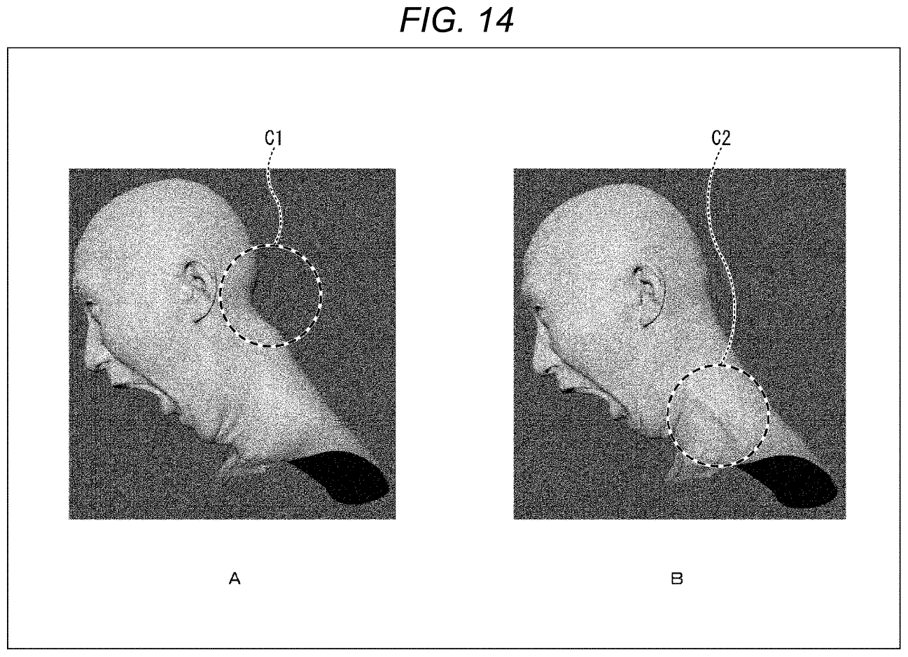

As indicated by a dashed circle C1 in A of FIG. 14, the related art has a problem where the volume of the occipital region is not preserved when the LBS is applied, and the mesh deforms inward into the head. On the other hand, in the technology according to the present disclosure, as described with reference to FIG. 8, the neck region that undergoes deformation includes the occipital region, allowing the neck base shape to incorporate displacement to ensure the volume preservation of the occipital region. This configuration can prevent, as illustrated in B of FIG. 14, the mesh from deforming inward into the head in the occipital region.

Furthermore, for example, in a case where the mouth is fully open like when pronouncing “A” in Japanese, real humans show a phenomenon in which the neck muscles are pulled by the facial muscles, but with the related art, representing such deformation is also challenging. On the other hand, in the technology according to the present disclosure, as the neck shape can be deformed on the basis of facial expressions, it is possible to represent a phenomenon in which the neck muscles are pulled by the facial muscles as indicated by a dashed circle C2 in B of FIG. 14 and prevent the neck shape from collapsing.

As described above, according to the technology according to the present disclosure, it is possible to represent neck deformation more realistically.

That is, by compressing neck deformation shapes through principal component analysis and associating facial expressions and neck rotation with linear regression coefficients of compressed bases through learning, it is possible to automatically generate neck deformation animation without requiring additional data other than meshes.

Furthermore, by performing modeling on the basis of the premise the facial expressions and degree of neck rotation are in a relationship of dependency with neck deformation, it is possible to prevent the neck shape from collapsing due to interference between facial expressions and neck rotation.

Moreover, by inputting facial expression features related to only some face mesh vertices closely associated with facial muscles to the machine learning module, it is possible to contribute to memory reduction and fast inference of the machine learning module.

Note that an example has been described where the technology according to the present disclosure is applied to a configuration that enables animation representation using Blend shape. Not limited to this, the technology according to the present disclosure can also be applied to, for example, a configuration that enables animation representation using helper bones.

### 8. Configuration Example of Computer

The series of processing described above may be performed by hardware, or may be performed by software. In a case where the series of processing is performed by software, a program forming the software is installed on a computer. Here, examples of the computer include a computer incorporated in dedicated hardware, a general-purpose personal computer capable of performing various functions by installing various programs, and the like.

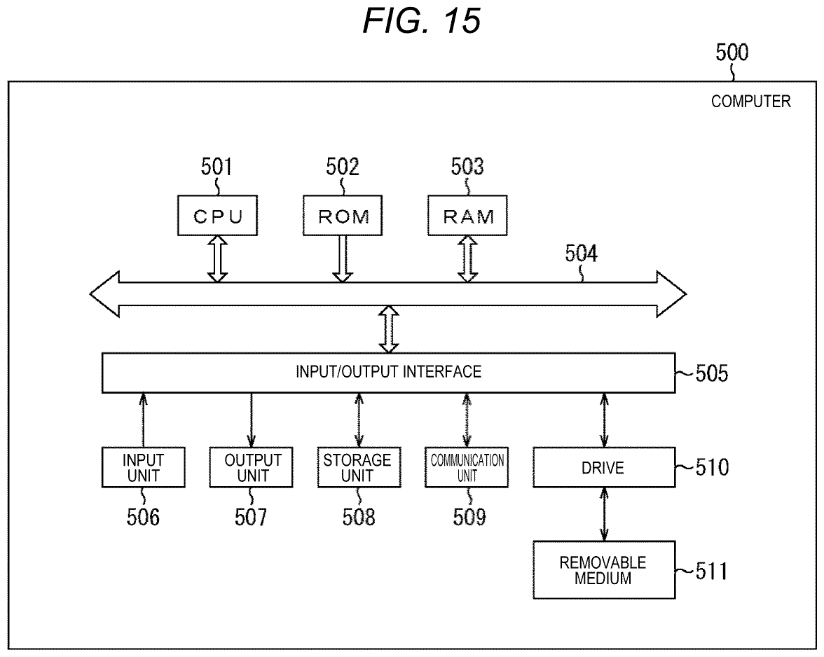

FIG. 15 is a block diagram illustrating a configuration example of hardware of a computer that performs the above-described series of processing in accordance with a program.

In the computer, a central processing unit (CPU) 501, a read only memory (ROM) 502, and a random access memory (RAM) 503 are interconnected by a bus 504.

An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, and the like. The output unit 507 includes a display, a speaker, and the like. The storage unit 508 includes a hard disk, a non-volatile memory, and the like. The communication unit 509 includes a network interface and the like. The drive 510 drives a removable medium 511 such as a magnetic disk, an optical disc, a magneto-optical disk, or a semiconductor memory.

In the computer configured as described above, for example, the CPU 501 loads a program stored in the storage unit 508 into the RAM 503 via the input/output interface 505 and the bus 504 and executes the program to perform the above-described series of processing.

The program executed by the computer (CPU 501) can be provided by being recorded on, for example, the removable medium 511 as a package medium or the like. Furthermore, the program can be provided via a wired or wireless transmission medium such as a local area network, the Internet, or digital satellite broadcasting.

In the computer, the program can be installed on the storage unit 508 via the input/output interface 505 by mounting the removable medium 511 onto the drive 510.

Furthermore, the program can be received by the communication unit 509 via the wired or wireless transmission medium and installed on the storage unit 508. Alternatively, the program can be pre-installed on the ROM 502 or the storage unit 508.

Note that the program to be executed by the computer may be a program that performs processing in time series in accordance with an order described in the present description, or may be a program that performs processing in parallel or at a necessary timing such as when a call is made.

The embodiment of the present disclosure is not limited to the above-described embodiments, and various modifications can be made without departing from the scope of the present disclosure.

The effects described in the present description are merely examples and are not limited, and other effects may be provided.

Moreover, the present disclosure may have the following configurations.

(1)

An information processing device including:
a neck mesh acquiring unit that acquires a neck mesh representing deformation of only a neck region from a training mesh representing a correlation between facial expression and neck deformation; and
a first learning unit that learns a plurality of neck base shapes and coefficients corresponding to, on a one-to-one basis, the plurality of neck base shapes on the basis of the neck mesh that has been acquired.
   (2)

The information processing device according to (1), in which
the neck mesh acquiring unit acquires the neck mesh by subtracting a facial expression mesh representing deformation of only a face region from the training mesh.
   (3)

The information processing device according to (2), in which
the neck mesh acquiring unit acquires the neck mesh by masking a region excluding the neck region in the training mesh from which the facial expression mesh has been subtracted.
   (4)

The information processing device according to (3), in which
the neck region includes a submandibular region and an occipital region.
   (5)

The information processing device according to any one of (1) to (4), in which
the first learning unit learns the plurality of neck base shapes by performing principal component analysis on the neck mesh.
   (6)

The information processing device according to any one of (1) to (5), in which
the first learning unit learns the coefficient for each of the plurality of neck base shapes by performing linear regression using the neck mesh and the neck base shapes.
   (7)

The information processing device according to any one of (1) to (6), further including:
a second learning unit that trains, using features representing deformation of the training mesh as input and the coefficients learned by the first learning unit as ground truth data, a machine learning module that infers the coefficient corresponding to a feature representing deformation of an arbitrary facial expression mesh.
   (8)

The information processing device according to (7), in which
the feature includes a degree of displacement of a feature point of the facial expression in the training mesh and a degree of neck rotation associated with the training mesh.
   (9)

The information processing device according to (8), in which
the feature point of the facial expression corresponds to a plurality of vertices around a mouth of the training mesh.
   (10)

The information processing device according to any one of (7) to (9), further including:
an inference unit that inputs the feature representing the deformation of the arbitrary facial expression mesh to the machine learning module to infer the coefficient using a weight obtained through the training of the machine learning module; and
a neck mesh generating unit that generates the neck mesh corresponding to the facial expression mesh by linearly combining the neck base shapes learned by the first learning unit using the coefficient that has been inferred.
   (11)

The information processing device according to (10), in which
the feature includes a degree of displacement of a feature point of the facial expression in the facial expression mesh and a degree of neck rotation associated with the facial expression mesh.
   (12)

The information processing device according to (11), in which
the feature point of the facial expression corresponds to a plurality of vertices around a mouth of the facial expression mesh.
   (13)

The information processing device according to any one of (10) to (12), further including:
a head-neck mesh output unit that outputs a head-neck mesh that results from applying the feature of the facial expression mesh to the neck mesh generated by the neck mesh generating unit.
   (14)

An information processing method including:
causing an information processing device to acquire a neck mesh representing deformation of only a neck region from a training mesh representing a correlation between facial expression and neck deformation; and
causing the information processing device to learn a plurality of neck base shapes and coefficients corresponding to, on a one-to-one basis, the plurality of neck base shapes on the basis of the neck mesh that has been acquired.
   (15)

A computer-readable recording medium storing a program for causing a computer to perform processing, the processing including:
acquiring a neck mesh representing deformation of only a neck region from a training mesh representing a correlation between facial expression and neck deformation; and
learning a plurality of neck base shapes and coefficients corresponding to, on a one-to-one basis, the plurality of neck base shapes on the basis of the neck mesh that has been acquired.

### REFERENCE SIGNS LIST

1 Information processing device
10 First learning mechanism
20 Second learning mechanism
30 Inference mechanism
110 Neck mesh acquiring unit
111 Inverse LBS applying unit
112 Facial expression mesh creating unit
113 Subtraction processing unit
114 Mask processing unit
120 First learning unit
121 Neck base shape learning unit
122 Linear regression coefficient learning unit
210 Feature extracting unit
211 Face feature point extracting unit
212 Neck rotation degree extracting unit
213 Vector combining unit
220 Second learning unit
221 Machine learning module
310 Neck rotation degree extracting unit
320 Face feature point extracting unit
330 Inference unit
340 Neck mesh generating unit
350 Head-neck mesh output unit
351 Adding unit
352 LBS applying unit

1. An information processing device comprising:
a neck mesh acquiring unit that acquires a neck mesh representing deformation of only a neck region from a training mesh representing a correlation between facial expression and neck deformation; and
a first learning unit that learns a plurality of neck base shapes and coefficients corresponding to, on a one-to-one basis, the plurality of neck base shapes on a basis of the neck mesh that has been acquired.

2. The information processing device according to claim 1, wherein
the neck mesh acquiring unit acquires the neck mesh by subtracting a facial expression mesh representing deformation of only a face region from the training mesh.

3. The information processing device according to claim 2, wherein
the neck mesh acquiring unit acquires the neck mesh by masking a region excluding the neck region in the training mesh from which the facial expression mesh has been subtracted.

4. The information processing device according to claim 3, wherein
the neck region includes a submandibular region and an occipital region.

5. The information processing device according to claim 1, wherein
the first learning unit learns the plurality of neck base shapes by performing principal component analysis on the neck mesh.

6. The information processing device according to claim 1, wherein
the first learning unit learns the coefficient for each of the plurality of neck base shapes by performing linear regression using the neck mesh and the neck base shapes.

7. The information processing device according to claim 1, further comprising:
a second learning unit that trains, using features representing deformation of the training mesh as input and the coefficients learned by the first learning unit as ground truth data, a machine learning module that infers the coefficient corresponding to a feature representing deformation of an arbitrary facial expression mesh.

8. The information processing device according to claim 7, wherein
the feature includes a degree of displacement of a feature point of the facial expression in the training mesh and a degree of neck rotation associated with the training mesh.

9. The information processing device according to claim 8, wherein
the feature point of the facial expression corresponds to a plurality of vertices around a mouth of the training mesh.

10. The information processing device according to claim 7, further comprising:
an inference unit that inputs the feature representing the deformation of the arbitrary facial expression mesh to the machine learning module to infer the coefficient using a weight obtained through the training of the machine learning module; and
a neck mesh generating unit that generates the neck mesh corresponding to the facial expression mesh by linearly combining the neck base shapes learned by the first learning unit using the coefficient that has been inferred.

11. The information processing device according to claim 10, wherein
the feature includes a degree of displacement of a feature point of the facial expression in the facial expression mesh and a degree of neck rotation associated with the facial expression mesh.

12. The information processing device according to claim 11, wherein
the feature point of the facial expression corresponds to a plurality of vertices around a mouth of the facial expression mesh.

13. The information processing device according to claim 10, further comprising:
a head-neck mesh output unit that outputs a head-neck mesh that results from applying the feature of the facial expression mesh to the neck mesh generated by the neck mesh generating unit.

14. An information processing method comprising:
causing an information processing device to acquire a neck mesh representing deformation of only a neck region from a training mesh representing a correlation between facial expression and neck deformation; and
causing the information processing device to learn a plurality of neck base shapes and coefficients corresponding to, on a one-to-one basis, the plurality of neck base shapes on a basis of the neck mesh that has been acquired.

15. A computer-readable recording medium storing a program for causing a computer to perform processing, the processing comprising:
acquiring a neck mesh representing deformation of only a neck region from a training mesh representing a correlation between facial expression and neck deformation; and
learning a plurality of neck base shapes and coefficients corresponding to, on a one-to-one basis, the plurality of neck base shapes on a basis of the neck mesh that has been acquired.
